(19) United States
(12) Patent Application Publication
(10) Pub. No.: US 2009/0144764 A1
(43) Pub. Date: Jun. 4, 2009

(54) BILLING ADJUSTMENT SYSTEM FOR MULTIMEDIA CONTENT

(75) Inventors: NEERAV MEHTA, Edison, NJ (US); PARITOSH BAJPAY, Edison, NJ (US); MONOWAR HOSSAIN, Middletown, NJ (US); THIRU ILANGO, Holmdel, NJ (US); CHEN YUI YANG, Marlboro, NJ (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/948,604

(22) Filed: Nov. 30, 2007

(51) Int. Cl. H04N 7/16

(52) U.S. Cl. 725/1

(57) ABSTRACT

A system and method is disclosed for processing refund requests. For IPTV broadcast programs, refund requests initiated by users may be for pay-per-view or on-demand programs. After accepting the refund request, user information and historical event information for the provider network are collected and analyzed using a set of rules. The refund request may be granted or denied, either in whole or in part, based on the user information and the historical event information. In addition, detection of network outages and service interruptions is correlated to the refund requests, whereby remediation service may be initiated for network components determined to be in a fault condition.

### BACKGROUND

1. Field of the Disclosure

The present disclosure generally relates to providing multimedia content, and more specifically, to processing refunds for purchased multimedia content.

2. Description of the Related Art

Multimedia content in the form of broadcast programs, such as video-on-demand movies or scheduled pay-per-view events, may be ordered by a consumer for viewing via a provider network. A consumer may request a refund for an ordered broadcast program, which may require a complex analysis of the situation by the provider. The refund request may also indicate a service issue in the provider network.

### BRIEF DESCRIPTION OF THE DRAWINGS

FIG. 1 illustrates a representative Internet Protocol Television (IPTV) system for implementing disclosed embodiments of a billing adjustment system;

FIG. 2 illustrates representative operations relating to an embodiment of a billing adjustment system; and

FIG. 3 depicts a data processing system in block diagram form that may be incorporated into disclosed embodiments of the billing adjustment system of FIG. 2.

### DESCRIPTION OF THE EMBODIMENT(S)

In one aspect, a method is disclosed for processing a refund request initiated by a user of a provider network. The method includes receiving the refund request and collecting user information. The method further includes indicating the status of the refund request to the user. The method still further includes retrieving a plurality of historical events associated with a plurality of components of the provider network. Based at least in part on the user information and the retrieved plurality of historical events, the method includes determining whether the refund request is granted. In some embodiments, based on the retrieved plurality of historical events, it is determined whether any of the components of the provider network require remediation service. In certain embodiments, the refund request is associated with a multimedia program offered for broadcast via the provider network. The aspect of collecting user information may include validating the identity of the user and verifying that the user ordered the multimedia program associated with the refund request. In some embodiments, the multimedia program is delivered on a pay-per-view basis. In certain embodiments, the multimedia program is delivered on an on-demand basis. The provider network may provide Internet protocol (IP) based television broadcasting, wherein the multimedia program includes a video and audio broadcast. Responsive to determining that the refund request is granted, the method may further include providing the user with a billing credit and notifying the user of the provided billing credit. In some embodiments, the user initiates the refund request using a set-top box (STB) enabled for bidirectional-communication with the provider network. In certain embodiments, the user initiates the refund request using a wireless communications device. In some embodiments, the user initiates the refund request using the Internet.

In another aspect, a computer-readable memory medium, including program instructions executable by a processor, is disclosed. The program instructions are executable to receive a refund request initiated by a client of a provider network, wherein the refund request is associated with an IPTV program requested by the network client or user via the provider network. The program instructions are further executable to receive client information and validate the location of the client using the client information. The program instructions are further executable to indicate the status of the refund request to the client. The program instructions are also executable to retrieve a plurality of event codes associated with the client from an event database, wherein the event codes are indexed to components of the provider network. Based at least in part on the client information and the retrieved plurality of event codes, the program instructions are executable to determine whether the refund request is granted. Based on the retrieved event codes, the program instructions may be executable to determine whether components of the provider network require remediation service. In some embodiments, the memory medium includes program instructions executable to initiate a request for remediation service for at least some of the components of the provider network. The IPTV program may be delivered on a pay-per-view basis. In some embodiments, the IPTV program is delivered on an on-demand basis. Responsive to determining that the refund request is granted, a refund may be credited to an account associated with the client and the client may be notified that the refund has been credited. The event code may include a video trouble code. In some embodiments, the IPTV program is delivered from a video hub office (VHO). In certain embodiments, the IPTV program is delivered from a satellite head-end office.

In an additional aspect, a system comprising a processor and a memory, including program instructions executable by the processor, is disclosed. The program instructions are executable to receive a refund request initiated by a user of a provider network, wherein the refund request is associated with an IPTV program requested by the user via the provider network. The program instructions are further executable to receive user information and validate the identity of the user using the user information. The program instructions are further executable to indicate the status of the refund request to the user. The program instructions are also executable to retrieve a plurality of event codes associated with the user from an event database, wherein the event codes are indexed to components of the provider network. Based at least in part on the user information and the retrieved plurality of event codes, the program instructions are also executable to determine whether the refund request is granted. In some embodiments, the system includes program instructions executable to initiate a request for remediation service for at least some of the components of the provider network. In certain embodiments, the event database includes a trouble validation engine that accesses the components of the provider network and stores the event codes. In some instances, the multimedia output is a voice message. In various embodiments, the multimedia output may be an instant message.

In the following description, for the purposes of explanation, numerous specific details are set forth in order to provide a thorough understanding of the disclosed embodiments. A person of ordinary skill in the art should recognize that embodiments may be practiced without some of these specific details. In other instances, well-known structures and devices may be shown in block diagram form or omitted for clarity.

Television programs, movies, radio programming and other multimedia content may be distributed over a “provider network,” which may include telephone company networks, coaxial-based networks, Ethernet networks, satellite transmissions, WiFi transmission, WiMAX transmission, and the like. In some systems, for example traditional coaxial-based “cable” systems, a service provider may distribute through the same coaxial or fiber-optic cable a compound signal containing a number of television channels at different frequencies. In conjunction, a set-top box or a tuner within a television, radio, or recorder selects one or more channels from the compound signal to play or record. In contrast to such systems that simultaneously distribute every available channel at all times, IPTV systems generally distribute content only in response to user requests. Such IPTV systems typically use IP and other technologies found in computer networks. To provide IPTV, a user's telephone lines may be used in some combination with a residential gateway (RG), a digital subscriber line (DSL) modem, a STB, a display, and other such equipment to receive and convert into usable form the multimedia content provided from a telephone company network, for example.

IPTV providers, satellite-based providers, digital cable providers, and others may distribute multimedia content using bidirectional (i.e., two-way) communication between a user's customer premises equipment and the service provider's equipment. In some embodiments, multimedia content is provided directly to a user's wireless communications device using IPTV, for example, streaming video and audio. Bidirectional communication allows a service provider to offer advanced features, such as video-on-demand (VOD), pay-per-view, advanced programming information, text-based news, and the like.

Accordingly, a user may order specific multimedia content (i.e., a program) to be delivered as an IPTV broadcast from the provider network. After the ordered program has been broadcast and viewed, the provider may have fulfilled its obligation and may charge the user for the multimedia content. The charge may also occur prior to the completion of the broadcast and viewing of the program. However, in some instances, the multimedia content may not be satisfactorily broadcast or may not reach the user in its entirety for some reason. For example, technical difficulties in any of the components of the provider network may cause an outage or a service interruption during the intended broadcast. Examples of such outages or interruptions provided herein are exemplary and it is noted that other causes and system configurations may also adversely affect an IPTV broadcast. Depending on the nature of the disruption and the type of program and content ordered by the user, grounds for a refund, in whole or in part, for the broadcast may exist. In some instances, even though the user has experienced a disruption in the broadcast program, the user may not be entitled to a refund, since the network provider has fulfilled its obligations to the user. Ascertaining the actual situation with respect to a given refund request may require substantial time, costs and other valuable resources to be expended by the provider.

Furthermore, knowledge of program outages and failures of network components, such as those associated with an IPTV broadcast, may arrive at the network provider after a refund request is received from one or more users. Depending on the number and location of the refund requests, the provider may establish the magnitude, impact and origin of network component faults. For example, an entire neighborhood can be serviced by a particular network switch. If the switch experiences an outage, the network provider would likely receive a large number of refund requests from the neighborhood. In some cases, correlation of these requests enables the network provider to quickly determine that the network switch in question should be serviced (i.e., tested, repaired, replaced, and/or otherwise remediated). Therefore, the number, timing and origin of refund requests, and other collected information, potentially provides valuable insights into the operational state of the network.

From the perspective of the user (i.e., customer), having alternative options to contact the provider and initiate a refund request provides increased convenience and value. Calling customer support to request the refund may be a time-consuming and inconvenient method for the user. For communicating the refund request to the provider, the user may prefer email, instant messaging, or using an Internet website on a personal computer, or the same options on a mobile communications device.

The methods and systems disclosed herein provide embodiments for processing refund requests. The processing includes accepting or rejecting a refund request and indicating the status of the refund request to the initiator of the refund request. The indication (or notification) may be in the form of a multimedia output, such as a text message, e-mail, audio message, voice message, or a graphical user interface (GUI) display. The disclosed embodiments are configurable to perform a wide range of inquiries from numerous sources of information for processing accepted refund requests. The processing may determine whether an accepted refund request is granted or denied. In some instances, determining the outcome includes providing a billing credit to the user (i.e., the purchasing entity). In some exemplary instances, the billing credit is refunded, in whole or in part, based on the charged amount. In some cases, the billing credit is refunded, in whole or in part, in the form of additional viewing time or viewing events for future use on the provider network. In certain embodiments, the user can choose different options for the type of refund desired. Furthermore, a notification may be provided to the user that the billing credit has been provided, if the refund is granted. Other notifications, such as those indicating a denied refund request, in whole or in part, may also be provided.

In some embodiments, the information collected from the refund request (or from a plurality of refund requests) is used at least in part to determine whether any components of the provider network are in a fault condition or should be serviced. Such a determination may include querying the components for an operational state, for example, by using a communications interface for the component. In some cases, the determination includes analyzing network traffic or performance data associated with the component. In some embodiments, the detection of a fault condition, or other determined state, results in initiating a service call to remediate the component or components in question.

In certain embodiments, the user is provided with parallel communication options with the provider, such as functions on a STB, instant messaging, an Internet website, or a voice-based interface, to initiate the refund request, and to receive notification of the status and of the outcome of the refund request. The provider may use any combination of communication means to send multimedia output, to the user, or to receive multimedia input from the user. The multimedia output may include indications or notifications to the user regarding the status or outcome of the refund request, as previously mentioned.

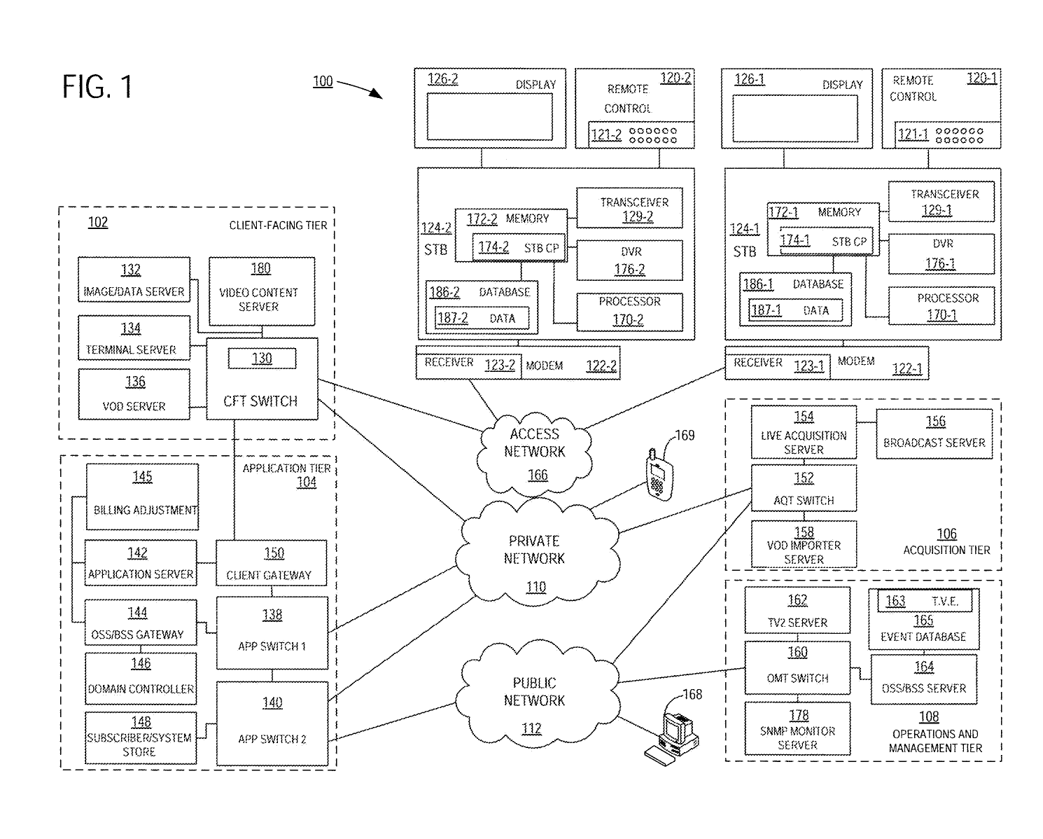

Referring now to the drawings, FIG. 1 illustrates selected aspects of an embodied IPTV system 100 operated as part of a service provider network. Throughout this disclosure, a hyphenated form of a reference numeral refers to a specific instance of an element and the un-hyphenated form of the reference numeral refers to the element generically or collectively. Thus, for example, reference numeral 124-1 refers to an instance of an element 124. As shown in FIG. 1, IPTV system 100 includes two set-top boxes (STBs) 124 including STB 124-1 and STB 124-2. In the depicted embodiment, STBs 124 communicate through access network 166 via modems 122 (i.e., modem 122-1 and modem 122-2).

As shown, IPTV system 100 is configured to provide multimedia content to users of STBs 124 and includes a client facing tier 102, an application tier 104, an acquisition tier 106, and an operations and management tier 108. Each tier 102, 104, 106 and 108 is coupled to a private network 110, to a public network 112 (e.g., the Internet), or to both the private network 110 and the public network 112. Any of the various tiers coupled to the various networks may communicate with each other over the networks. For example, as shown, the client-facing tier 102 may communicate through the private network 110 with the acquisition tier 106. Further, as shown, the application tier 104 may communicate through the private network 110 and the public network 112 with the acquisition tier 106. The interconnections between illustrated tiers and networks in FIG. 1 are meant as instructive and not limiting.

As shown, IPTV system 100 distributes multimedia content to users of STBs 124 for viewing on displays 126 and possibly for sending to other components not shown, such as stereo equipment. In order to distribute the multimedia content, IPTV system 100 first gains access to the multimedia content. To that end, acquisition tier 106 represents a variety of systems to acquire multimedia content, reformat it when necessary, and prepare it for transmission over private network 110 or public network 112. In its capacity as acquiring and distributing multimedia for use on IPTV system 100, acquisition tier 106 serves as a “content headend.” Acquisition tier 106 may include, for example, systems for capturing analog and/or digital content feeds, either directly from a content provider or from a content aggregation facility. Content feeds transmitted via VHF/UHF broadcast signals may be captured by broadcast server 156. Similarly, live acquisition server 154 may capture satellite signals, high-speed fiber feeds, or programming feeds sent over other suitable transmission means. Content feeds to live acquisition server 154 may include broadcasted multimedia content, for example premium audio/video programming (i.e., traditional “cable channels”) widely available but not typically broadcast over airwaves. Acquisition tier 106 may further include signal conditioning systems and content preparation systems for encoding content. As shown, acquisition tier 106 includes VOD importer server 158 and may include a digital rights management (DRM) server for encrypting content (not shown). VOD importer server 158 receives content from one or more VOD sources that may be outside the IPTV system 100, for example discs or transmitted feeds. VOD importer server 158 may temporarily store multimedia content for transmission to a VOD server 136 on client-facing tier 102. In addition, the VOD content may be stored at one or more servers, such as the VOD server 136. The stored VOD content may be distributed by multicast (i.e., a single stream sent simultaneously to multiple viewers) or by unicast to individual users in a VOD system.

After acquiring the multimedia content, IPTV system 100 distributes the content over private network 110, for example. Private network 110 may be referred to as a “core network.” In some embodiments, private network 110 consists of a fiber backbone (i.e., wide area network) and one or more VHOs. Generally, private network 110 transports multimedia content (e.g., video, music, Web pages, channel lineups, and data) from the acquisition tier 106 to STBs 124 through access network 166 (via client-facing tier (CFT) switch 130). In this role, private network 110 serves as the “backbone” for IPTV system 100. In a large deployment of IPTV system 100 that covers a vast geographic region, private network 110 may represent several smaller networks that each may only transfer content within a subset of the region. Accordingly, private network 110 may provide for the insertion of local content that is relevant only to a subset region. For example, private network 110 may allow for the localized insertion of local advertisements or local emergency alert systems for a particular service area.

To illustrate the distribution of multimedia content acquired by acquisition tier 106, in an example embodiment, broadcast server 156 acquires broadcast multimedia content and communicates it to live acquisition server 154. Live acquisition server 154 transmits the multimedia content to the AQT (AcQuisition Tier) switch 152. In turn, the AQT switch 152 transmits the multimedia content to the CFT switch 130, for example, via the private network 110. As shown, the CFT switch 130 may communicate the multimedia content through modems 122 via the private access network 166. In some embodiments, STBs 124 receive the multimedia content via modems 122 and transmit it to displays 126.

In some embodiments, live acquisition server 154 and VOD importer server 158 take numerous data streams and encode them into a digital video format, such as MPEG-2, or MPEG-4. After encoding, data streams may be encapsulated into IP data streams and transmitted to specific IP destinations (e.g., STBs 124) in response to a user's request for a particular channel, for example. Video content server 180, VOD server 136, or image/data server 132 may act as an intermediary or repository for multimedia content obtained and encoded by acquisition tier 106. In some embodiments, multimedia content is transmitted to the video content server 180, where it is encoded, formatted, stored, or otherwise manipulated and prepared for communication to the STB 124.

As shown, IPTV system 100 includes access network 166. Access network 166 provides a network link from the private network 110 to each consumer's location. To this end, access network 166 provides a network translation as necessary from a switched network, for example, to the access technology used to transmit data and multimedia content to the consumer's location. For example, a service provider that uses twisted-pair telephone lines to deliver multimedia content to consumers or clients may utilize digital subscriber lines within access network 166. The digital subscriber lines may utilize some combination of DSL, DSL2, DSL2+, ADSL, VDSL or other technologies. In some embodiments, access network 166 may use fiber-to-the-home. In such cases, optical fiber may be used all the way to the consumer's location to easily provide high-bandwidth. In other embodiments, fiber-to-the-curb deployments are used to deliver multimedia content to consumers. In such cases, a digital subscriber line access multiplexer may be used within access network 166 to transfer signals containing multimedia content from optical fiber to copper wire for DSL delivery to consumers. In other embodiments, access network 166 may use radio frequency (RF) signals sent over coaxial cables. Accordingly, access network 166 may utilize quadrature amplitude modulation equipment for downstream traffic. In these systems, access network 166 may receive upstream traffic from a consumer's location using quadrature phase shift keying modulated RF signals. In such systems, a cable modem termination system may be used to mediate between IP-based traffic on private network 110 and access network 166.

In operation, if a user requests VOD content via an STB 124, the request may be transmitted over the access network 166 to VOD server 136, via the CFT switch 130. Upon receiving the request, the VOD server 136 retrieves or accesses the requested VOD content and transmits the content to the STB 124 across access network 166 via CFT switch 130. In turn, STB 124 transmits relevant video portions of the VOD content to the display 126. STB 124 may transmit audio portions of the VOD content to a stereo system (not shown) or may allow (or disallow) sending the VOD content to a recording device (not shown).

As shown, IPTV system 100 includes application tier 104. Application tier 104 communicates with acquisition tier 106 and client-facing tier 102 through private network 110. Application tier 104 may communicate through various communication protocols including hypertext transfer protocol (HTTP). Generally, application tier 104 may include notification servers, billing servers, and any of a variety of subscriber application servers employed by an owner or operator (i.e., network service provider) of IPTV system 100. In some embodiments, elements of the application tier 104 such as client gateway 150 communicate directly with the client-facing tier 102. The components of client-facing tier 102 may communicate using HTTP, transmission control protocol (TCP) or datagram protocol (UDP), as examples.

As illustrated in FIG. 1, the client-facing tier 102 is coupled for communication with user equipment (e.g., modems 122) via access network 166. Access network 166 may be referred to as the “last mile” for a service provider or network operator. It provides network connectivity of IPTV services to consumers' locations. Client-facing tier 102 may multicast multimedia content to multiple destinations. For example, the same multimedia content may be distributed substantially simultaneously to STB 124-1 and STB 124-2. In contrast to a multicast or a unicast, some embodiments “broadcast” programming or data to all users on a network as a “broadcast” transmission. For example, a TV guide feature for displaying available programming may be broadcast to every user.

To deliver multimedia content, client-facing tier 102 may employ any current or future Internet protocols for providing reliable real-time streaming multimedia content. In addition to the TCP, UDP, and HTTP protocols discussed above, such protocols may use, in various combinations, other protocols including, file transfer protocol (FTP), real-time transport protocol (RTP), real-time control protocol (RTCP), and real-time streaming protocol (RTSP), as examples. In some embodiments, client-facing tier 102 sends multimedia content encapsulated into IP packets over access network 166. For example, an MPEG-2 transport stream may be sent, in which the transport stream consists of a series of 188-byte transport packets. To ensure quality of service, protocols should be chosen that minimize dropped packets, jitter, delay, data corruption, and other errors.

As shown, modems 122 include a receiver 123 for receiving data. As shown, the client-facing tier 102 may communicate with a large number of STBs, such as representative STBs 124, over a wide area, which may be for example, a regional area, a metropolitan area, a viewing area, a designated market area, or any other suitable geographic area, market area, or user group supported by networking the client-facing tier 102 to numerous STBs. In an illustrative embodiment, the client-facing tier 102, or any portion thereof, may be included at a video headend office (not depicted).

In some embodiments, the client-facing tier 102 may be coupled to modems 122 via fiber optic cables. Alternatively, modems 122 may be DSL modems coupled to one or more network nodes via twisted pairs. Each STB 124 may process data received over the private access network 166 via various IPTV software platforms that are commonly known.

In an illustrative embodiment, the client-facing tier 102 includes a CFT switch 130 that manages communication between the client-facing tier 102 and the private access network 166. CFT switch 130 also manages communication between the client-facing tier 102 and the private network 110 and is coupled to an image/data server 132 that may store streaming multimedia content and possibly still images associated with programs of various IPTV channels. Image/data server 132 stores data related to various channels, for example, types of data related to the channels and to programs or video content displayed via the channels. In an illustrative embodiment, image/data server 132 may be a cluster of servers, each of which may store streaming multimedia content, still images, channel and program-related data, or any combination thereof CFT switch 130 may also be coupled to terminal server 134 that provides terminal devices with a connection point to the private network 110. As shown, CFT switch 130 may also be coupled to VOD server 136 that stores or provides VOD content imported by the IPTV system 100. As shown, the client-facing tier 102 also includes video content server 180 that transmits video content requested by viewers to STBs 124. In some embodiments, video content server 180 includes one or more multicast servers.

As illustrated in FIG. 1, application tier 104 may communicate with numerous components through private network 110 and public network 112. As shown, application tier 104 includes a first application tier (APP) switch 138 and a second APP switch 140. The first APP switch 138 is coupled to the second APP switch 140 and a combination operation-systems-support (OSS) and billing-systems-support (BSS) gateway 144 (i.e., OSS/BSS gateway 144). In some embodiments, the OSS/BSS gateway 144 controls access to an OSS/BSS server 164 that stores operations and billing systems data.

As shown, application tier 104 includes application server 142. Application server 142 may be any data processing system with associated software that provides information services (i.e., applications) for clients or users. Application server 142 may be optimized to provide services including conferencing, voicemail, and unified messaging. In some embodiments, services include electronic programming guides (EPG), conditional access systems (CAS), DRM servers, a navigation/middleware server, and IPTV portal, e-mail services, and remote diagnostics. As shown, application server 142 is associated with or communicates with billing adjustment application 145, which as will be described in detail below, is configured to process refund requests according to the methods described herein.

As shown in FIG. 1, second APP switch 140 is communicatively coupled to a domain controller 146 that provides web access, for example, to users via the public network 112. The second APP switch 140 is communicatively coupled to a subscriber/system store 148 that includes account information, such as account information that is associated with users who access the IPTV system 100 via the private network 110 or the public network 112. Therefore, for example, a user may employ a personal computer (PC) 168 to receive IPTV account information via the public network 112. Similarly, a user may employ cellular telephone 169 or another similar multifunction device over private network 110 or public network 112 to receive information through second APP switch 140. In some embodiments, application tier 104 may also include a client gateway 150 that communicates data directly with the client-facing tier 102. In these embodiments, the client gateway 150 may be coupled directly to the CFT switch 130. Accordingly, the client gateway 150 may provide user access to the private network 110 and the tiers coupled thereto.

In some embodiments, STB 124 accesses the IPTV system 100 via the private access network 166, using information received from the client gateway 150. In such embodiments, private access network 166 may provide security for the private network 110. Therefore, user devices may access the client gateway 150 via the private access network 166, and the client gateway 150 may allow such devices to access the private network 110 once the devices are authenticated or verified. Similarly, the client gateway 150 may prevent unauthorized devices, such as hacker computers or stolen STBs, from accessing the private network 110, by denying access to these devices beyond the private access network 166.

Accordingly, in some embodiments, when an STB 124 accesses the IPTV system 100 via the private access network 166, the client gateway 150 verifies user information by communicating with the subscriber/system store 148 via the private network 110, the first APP switch 138, and the second APP switch 140. The client gateway 150 verifies billing information and user status by communicating with the OSS/BSS gateway 144 via the private network 110 and the first APP switch 138. The OSS/BSS gateway 144 may transmit a query across the first APP switch 138, to the second APP switch 140, and the second APP switch 140 may communicate the query across the public network 112 to the OSS/BSS server 164. Upon the client gateway 150 confirming user and/or billing information, the client gateway 150 allows the STB 124 access to IPTV content, VOD content, and other services. If the client gateway 150 cannot verify user information for the STB 124, for example, because it is connected to an unauthorized twisted pair or RG, the client gateway 150 may block transmissions to and from the STB 124 beyond the private access network 166.

STBs 124 convert digital compressed signals into a format suitable for display. STBs 124 have functionality for recognizing and acting on IP packets, for example UDPs transmitted within IP datagrams. STBs 124 may contain software or firmware coding for sending requests to application server 142, for example, to receive requested programming or data. In some embodiments, requests for content (e.g., VOD content) flow through a billing or management server to verify that a user is not in arrears regarding payment. In some embodiments, STB 124 supports Web browsing on the Internet (e.g., public network 112) and may support cycling through guide data, for example, using Web services. Each STB 124 may be enabled for viewing e-mail, viewing e-mail attachments, and interfacing with various types of home networks.

In accordance with disclosed embodiments, each STB 124 may be a cable box, a satellite box, or an electronic programming guide box. Further, although shown separately, STBs 124 may be incorporated into any multifunctional device such as, a television, a videocassette recorder, a digital video recorder, a computer, a personal computer media player, or other media device. Generally, STBs 124 each represent a dedicated data processing system (e.g., computer) that provides an interface between a display and a service provider. As shown, STBs 124 are connected to the service provider through modems 122. Although modems are shown in FIG. 1, other RGs may be employed. Alternatively, STBs 124 may be connected directly to access network 166.

STBs 124 contain software or firmware instructions stored in memories 172 or other storage for receiving and processing input from remote controls 120. In some embodiments, STBs 124 are IP based STBs and have capability for outputting resultant multimedia signals (e.g., streaming audio/video) in various formats including S-video, composite video, high definition component video, high definition multimedia interface, and video graphics array signals. The resultant multimedia signals may support displays 126 that have various video modes including analog NTSC, 1080i, 1080p, 480i, 480p, 720p, as examples. In some embodiments, STBs 124 communicate with modems 122 over local area networks connected using CAT5 cables, CAT6 cables, wireless interfaces, or a Home Phoneline Networking Alliance network, as examples.

As shown STBs 124 are coupled to displays 126. Each display 126 may include a cathode ray tube (CRT), television, monitor, projected image, liquid crystal display (LCD) screen, holograph, or other graphical equipment.

STBs 124 communicate with remote controls 120. STBs 124 may include wireless transceivers 129 to communicate with wireless transceivers (not shown) of remote controls 120. Although the term “buttons” is used to describe some embodiments herein, other forms of input may be used. For example, touch screens associated with remote controls 120 may be used to accept user input. Alternatively, remote controls 120 may be used in conjunction with STBs 124 to operate GUIs displayed on displays 126.

STBs 124 as shown receive data 187, which may include video content and/or audio content or portions, from the client-facing tier 102 via the private access network 166. Data 187 may be associated with at least one program, such as a broadcast program, that includes streaming multimedia content. As it receives data 187, STB 124 may store the content or may format the content into a resultant multimedia signal for sending to displays 126 and other equipment (not shown) for producing portions of the multimedia content in usable form.

As shown, each STB 124 includes an STB processor 170 and an STB memory 172 that is accessible by STB processor 170. An STB computer program (STB CP) 174, as shown, is embedded within each STB memory 172. As shown, memories 172 are coupled with databases 186 that each include data 187.

In addition to or in conjunction with STB components illustrated in FIG. 1, STBs 124 may contain modules for transport, de-multiplexing, audio/video encoding and decoding, audio digital to analog converting, and RF modulation. For clarity, such details for these modules are not shown in FIG. 1. In addition, details are not provided for allowing STBs 124 to communicate through access network 166 through modems 122. However, such communications can be carried out with known protocols and systems for network interfacing such as conventional network interface cards used in personal computer platforms. For example STB 124 may use a network interface that implements level 1 (physical) and level 2 (data link) layers of a standard communication protocol stack by enabling access to a twisted pair or other form of physical network medium and supporting low level addressing using media access control (MAC) addressing. In these embodiments, STBs 124 may each have a network interface including a globally unique 48-bit MAC address stored in a read only memory (ROM) or other persistent storage element. Similarly, each modem 122 (or other RG) may have a network interface (not depicted) with its own globally unique MAC address. Further, although STBs 124 are depicted with various functions in separate components, these components may be implemented with a system on chip (SoC) device that integrates two or more components.

As shown, STBs 124 may also include a video content storage module, such as a digital video recorder (DVR) 176. In a particular embodiment, STBs 124 may communicate commands received from the remote control devices 120 to the client-facing tier 102 via the private access network 166. Commands received from the remote control devices 120 may be entered via buttons 121.

IPTV system 100 includes an operations and management tier 108 that has an operations and management tier (OMT) switch 160. OMT switch 160 conducts communication between the operations and management tier 108 and the public network 112. The OMT switch 160 is coupled to a TV2 server 162. Additionally, the OMT switch 160 as shown is coupled to an OSS/BSS server 164 and to a simple network management protocol monitor server 178 that monitors network devices within or coupled to the IPTV system 100. In some embodiments, the OMT switch 160 communicates with the AQT switch 152 via the public network 112. The operations and management tier 108 may also include an event database 165, shown coupled to OSS/BSS server 164 in FIG. 1. In some embodiments, event database 165 includes a trouble validation engine 163 that collects and stores information about network components. Other implementations of the trouble validation engine may be usable with the methods described herein.

In an illustrative embodiment, the live acquisition server 154 transmits the multimedia content to the AQT switch 152, and the AQT switch 152, in turn, transmits the multimedia content to the OMT switch 160 via the public network 112. In turn, the OMT switch 160 transmits the multimedia content to the TV2 server 162 for display to users accessing the user interface at the TV2 server 162. For example, a user may access the TV2 server 162 using a PC 168 coupled to the public network 112.

In some embodiments, the channels include broadcast channels sent over coaxial cables. The channels may also include broadband channels, for example high-speed, high-capacity data transmission channels that send and receive information on cable. The cable, which may be coaxial cable or fiber-optic cable, may have a wider bandwidth than conventional telephone lines, and may have the ability to carry video, voice, data, and other multimedia content simultaneously.

Embodiments disclosed herein use IPTV system 100 to receive refund requests initiated by a user. The refund request may be initiated by the user using a wireless communication device, such as cellular telephone 169 or remote control 120, or other device. The refund request may also originate from a network client system, such a PC 168 or STB 124. In some embodiments, the user accesses or operates an Internet website of the provider using PC 168 to initiate the refund request. In some embodiments, the refund request is initiated using a button 121 on remote control 120 or a graphical user element on display 126. In certain embodiments, the refund request is initiated using a voice interface from an analog or VOIP phone (not shown), cellular telephone 169, or via STB 124. In certain embodiments, an instant messaging environment on PC 168, cellular telephone 169, STB 124, or other personal wireless device (personal data assistant (PDA), smart phone, mobile computer, etc.) is used to initiate the refund request.

Upon initiation of the refund request, billing adjustment application 145 may become activated, or is invoked as a user application, and is used to process the refund request, according to the methods described herein. The billing adjustment application 145 may interact with the user according to the method used to initiate the refund request, and is configured to enable different user interface options, selections, navigation menus, etc. for the respective interface. In some embodiments, billing adjustment application 145 uses a text interface in an instant messaging environment to provide a user interface. In certain embodiments, billing adjustment application 145 uses a voice menu, providing audio instructions and interpreting speech or dial-tone inputs by the user as program commands. In some embodiments, the user can mix or select the type of interface option desired. For example, in a voice menu, the user may choose to have a confirmation message sent to a specific address, such as an instant messaging or an e-mail account. In other embodiments, the user can select a call-back option on a voice phone from an Internet website to process the refund request.

In some embodiments, billing adjustment application 145 executes on, or communicates with, application server 142, which can be used to provide user applications in numerous environments, as discussed above. In some embodiments, billing adjustment application 145 receives user information from the user for processing the refund request. In certain embodiments, billing adjustment application 145 accesses subscriber/system store 148 via application server 142 to retrieve user information relevant to the refund request. For example, billing adjustment application 145 may query subscriber/system store 148 to determine the account standing of the user and other relevant user information, such as the user's refund activity with the provider over a period of time. The above examples of user information are not limiting and various other types of user information may be retrieved.

As shown in the embodiment disclosed by FIG. 1, billing adjustment application 145 accesses OSS/BSS gateway 144, which in turn provides access to OSS/BSS server 164, as described above. The billing adjustment application 145 may access OSS/BSS server 164 for the purpose of retrieving historical event information (i.e., “historical events”) about one or more network components that are related to the refund request. For example, the billing adjustment application 145 may query OSS/BSS server 164 to determine if the program for which a refund is requested was actually broadcast at the user's location, and query any logged events associated with the broadcast. The billing adjustment application 145 may thus determine that the program was broadcast without any reported errors. In some cases, the billing adjustment application 145 may retrieve event codes, which provide status or debugging information for a particular broadcast, time, location, network component, or a combination thereof In some embodiments, the event codes are video trouble codes that describe standardized errors with IPTV and other types of video broadcasting. In certain embodiments, billing adjustment application 145 accesses an event database that includes a trouble validation engine, which, in turn, accesses the components of the provider network and stores the event codes for network components. The historical events may also be derived from, or include, performance logs of network equipment, which can indicate if network traffic was flowing normally at a given time and/or location.

In some embodiments, billing adjustment application 145, in response to collecting user information and historical events, such as event codes, determines whether the submitted refund request may be accepted or rejected, and then may determine whether an accepted refund request is granted or denied. In some cases, a rejected refund request is not processed further and is thus denied. In certain embodiments, an accepted refund request is subject to additional analyses to determine if a refund or billing credit is granted, either in whole or in part. For example, the processing of a refund request may determine that a user ordered the IPTV program in question. However, a further analysis may prove that the IPTV program was played without error on the user's display and on numerous other displays of other users in the same vicinity, which may be used by billing adjustment application 145 to deny the refund request. Other rules and algorithms for validating and approving refund requests may be implemented by billing adjustment application 145, as desired. In some embodiments, a granted refund request is provided with a billing credit. In addition to determining whether a refund request is granted or denied, billing adjustment application 145 may interface with operations and management tier 108 to initiate or perform the billing adjustment. In some embodiments, data records in subscriber/system store 148 are modified to provide a billing credit to a user requesting a refund.

In some embodiments, billing adjustment application 145, in receiving refund requests from users, determines that certain network components or facilities are in a fault condition, for example as discussed above. The billing adjustment application 145 may further initiate requests for repair or remediation service for such network components found to be faulty. In some embodiments, billing adjustment application 145 sends appropriate messages to operations and management tier 108 to initiate remediation services for affected network components.

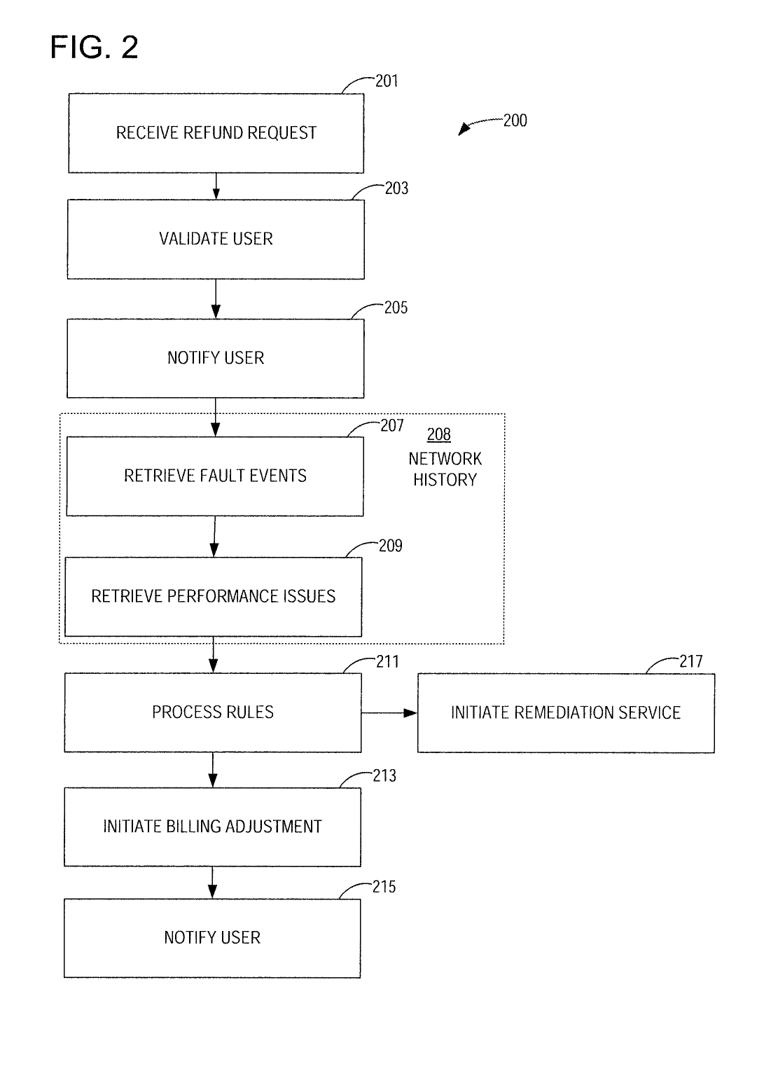

FIG. 2 illustrates in block diagram form a methodology 200 for processing refund requests. It is noted that individual operations described in methodology 200 may be optional or performed in a different sequence, depending on the specific embodiment. In some embodiments, the methodology 200 is performed by billing adjustment application 145 of IPTV system 100. In operation 201, a refund request initiated by a user is received. As described in detail above, the refund request may be received via a variety of interface channels, such as voice, instant messaging, Internet website, STB, remote control function, e-mail, etc. In some cases, the refund request is analyzed for completeness upon receipt, which may result in additional information being collected from the user or from a network client system. In certain embodiments, at least some portion of the analysis for validating or approving the refund request is performed in operation 201. In some embodiments, an incomplete, or otherwise unacceptable refund request may be rejected in operation 201.

In operation 203, the requesting user is validated to determine if the user is entitled to request a refund, such that the refund request may be accepted for further processing. For example, the user's account standing, identity, account history, or other user information, including information related to a client network device associated with the user, may be collected and used to determine if the user is entitled to request a refund. The location of the user (or a network client device of the user) may also be checked in operation 203, for example, to correlate instances of known network outages or other geographic conditions. Operation 203 may further include verifying that the user ordered the multimedia program associated with the refund request. In some instances, the requesting user is not validated in operation 203, because it has been determined that the user does not have standing to request a refund. For example, a refund request may be rejected if no record (i.e., a receipt) of the user ordering the multimedia program in question is found. In certain cases, the requesting user is validated in operation 203, the refund request is accepted, and the method continues to operation 205. In operation 205, the user may be notified of the status of the refund request. For example, the user may be notified in operation 205 that the refund request has been accepted. In some cases, the user is further notified that the refund request is being processed, or notified of a result of additional processing. In some embodiments, the notification in operation 205 is combined with a request for additional information from the user. The notification to the user in operation 205 may be in the form of a multimedia output, such as a text message, e-mail, audio indicator, voice message, or a display element on a GUI, and may provide an option for the user to respond, confirm, or provide additional information.

Operations 207 and 209 are shown in FIG. 2 in one embodiment as elements of operation group 208. Operation group 208 includes retrieving historical events about the provider network, for example, event codes related to network components. The historical events can also include performance logs for network components or network subsystems, or sub networks. In operation 207, fault events for network components related to the refund request are retrieved and analyzed. In certain embodiments, operation 207 involves the direct querying of network components to collect event codes. In some embodiments, a database is queried in operation 207 to obtain historical events, such as fault events, event codes, and/or video trouble codes, for a plurality of network components. In operation 209, performance logs, error logs and any recorded performance issues are retrieved. Thus, upon completion of the operation group 208, the network history, in terms of fault events and performance issues, is made available for further analysis.

In operation 211, a set of rules may be applied to the information collected thus far in method 200, including user information and historical events. The process rules implement the provider's policy on providing refunds, and may include numerous logical and contingent conditions associated with various data and information. In determining the outcome of the refund request, the rules may include further queries from IPTV system 100, as well as requests for additional information from the user or external sources. In some instances, the rules may result in an indeterminate outcome and require manual approval. In certain embodiments, the rules may be implemented in program instructions executable on a processor. A system implementing the rules in operation 211 may be configured to simultaneously process a large number of refund requests in a very short time, and thus serve a large number of users of IPTV system 100. One result of operation 211 may be the initiation of remediation service in operation 217 for network components found to be in a fault condition or otherwise requiring service. In some embodiments, operation 217 is not performed. In operation 211, the response of the provider to the refund request is determined according to the set of rules. As discussed previously, the refund request may be granted or denied, either in whole or in part, in operation 211. In some embodiments of operation 211, an indeterminate outcome may result for a refund request, which may in turn require additional action or information from the user or the network provider.

In operation 213, the result of operation 211 is implemented. In some cases, the refund request is denied in operation 211, and operation 213 is omitted. In some instances, a billing adjustment is initiated in operation 213 based on a determination that a refund request was granted in operation 211. Initiating the billing adjustment may include modifying account information stored in operations and management tier 108 and/or application tier 104. In some embodiments, initiation of billing adjustments in operation 213 causes additional operations (not shown) to be executed in IPTV system 100, depending on the type of billing adjustment. As discussed above, billing adjustments, such as those initiated in operation 213, may be in the form of monetary value or service credits for the provider network, for either in whole or in part of the requested refund amount.

In operation 215, the user is notified of the updated status of the refund request. The updated status may include the results of operation 211. In some embodiments, a notification of the denial of the refund request is provided in operation 215. In certain embodiments of operation 215, the user is notified that the refund request has been granted and is provided with details of the billing adjustment performed in operation 213. In some embodiments, the user is notified that the refund request has been denied in part (or granted in part) in operation 215. It is noted that the user notification in operation 215 may be any form of multimedia output through a variety of communication and interface channels, as discussed with respect to operation 205.

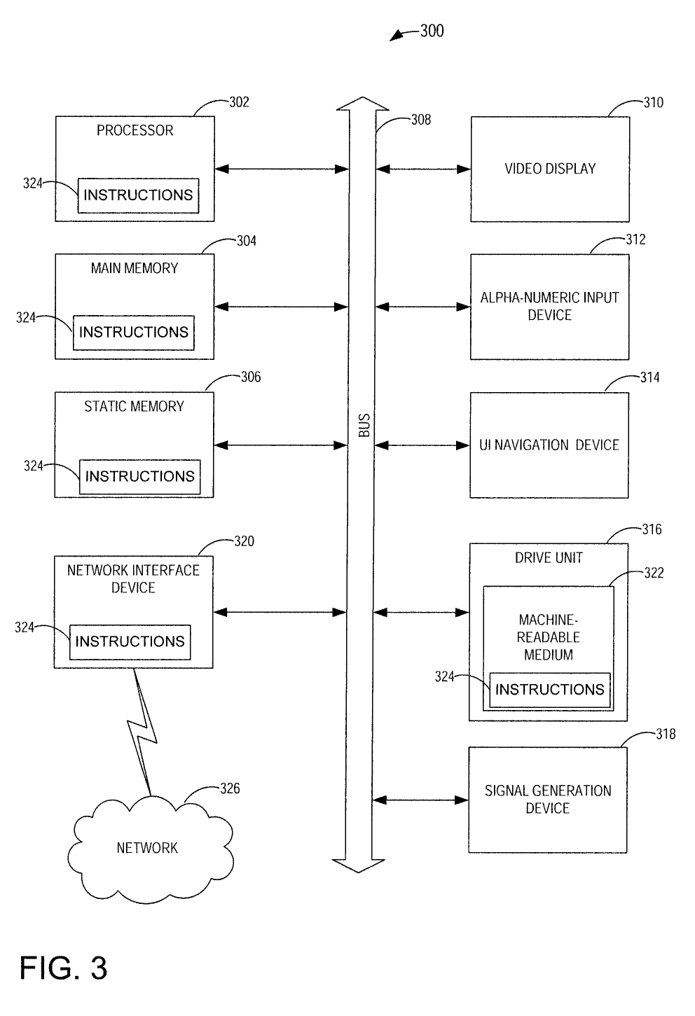

FIG. 3 is a diagrammatic representation of a machine in the example form of a computer system 300 within which a set of instructions for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a DVR, PC, a tablet PC, STB, a cable box, a satellite box, an EPG box, a PDA, a cellular telephone, a smart phone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit, a graphics processing unit or both), a main memory 304 and a static memory 306, which communicate with each other via a bus 308. The main memory 304 and/or the static memory 306 may be used to store the channel history data. The computer system 300 may further include a video display unit 310 (e.g., a television, an LCD or a CRT) on which to display broadcast or other programs, for example. The computer system 300 also includes an alphanumeric input device 312 (e.g., a keyboard or a remote control), a user interface (UI) navigation device 314 (e.g., a remote control or a mouse), a disk drive unit 316, a signal generation device 318 (e.g., a speaker) and a network interface device 320. The input device 312 and/or the UI navigation device 314 (e.g., the remote control) may include a processor (not shown), and a memory (not shown). The disk drive unit 316 includes a machine-readable medium 322 on which is stored one or more sets of instructions and data structures (e.g., instructions 324) embodying or utilized by any one or more of the methodologies or functions described herein (e.g., the software to access the channel history data in the database 186). The instructions 324 may also reside, completely or at least partially, within the main memory 304, within static memory 306, within network interface device 320, and/or within the processor 302 during execution thereof by the computer system 300.

The instructions 324 may further be transmitted or received over a network 326 (e.g., a television cable provider) via the network interface device 320 utilizing any one of a number of well-known transfer protocols (e.g., broadcast transmissions, HTTP). While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosed subject matter, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, they are not intended to limit the subject matter of the claims to the particular forms set forth. On the contrary, they are intended to cover such alternatives, modifications and equivalents as may be included within the spirit and scope of the subject matter as defined by the appended claims.

What is claimed is:

1. A method of processing a refund request initiated by a user of a provider network, the method comprising:
receiving the refund request;
collecting user information;
retrieving a plurality of historical events associated with a plurality of components of the provider network; and
based at least in part on the user information and the retrieved plurality of historical events, determining whether the refund request is granted.

2. The method of claim 1, further comprising:
based on the retrieved plurality of historical events, determining whether any of the components of the provider network require remediation service.

3. The method of claim 1, wherein the refund request is associated with a multimedia program offered for broadcast via the provider network.

4. The method of claim 3, wherein collecting user information includes:
validating the identity of the user; and
verifying that the user ordered the multimedia program associated with the refund request.

5. The method of claim 3, wherein the multimedia program is delivered on a pay-per-view basis.

6. The method of claim 3, wherein the multimedia program is delivered on an on-demand basis.

7. The method of claim 3, wherein the provider network provides Internet protocol based television broadcasting; and wherein the multimedia program includes a video and audio broadcast.

8. The method of claim 1, further comprising:
responsive to determining that the refund request is granted, providing the user with a billing credit; and
notifying the user of the provided billing credit.

9. The method of claim 1, wherein the user initiates the refund request using a set-top box enabled for bidirectional-communication with the provider network.

10. The method of claim 1, wherein the user initiates the refund request using a wireless communications device.

11. The method of claim 1, wherein the user initiates the refund request using the Internet.

12. A computer-readable memory medium, including program instructions executable by a processor to:
receive a refund request initiated by a client of a provider network, wherein the refund request is associated with an Internet protocol television program requested by the client via the provider network;
receive client information;
validate the location of the client using the client information;
retrieve a plurality of event codes associated with the client from an event database, wherein the event codes are indexed to components of the provider network; and
based at least in part on the client information and the retrieved plurality of event codes, determine whether the refund request is granted.

13. The computer-readable memory medium of claim 12, further including program instructions executable to:
based on the retrieved plurality of event codes, determine whether any of the components of the provider network require remediation service.

14. The computer-readable memory medium of claim 13, further including program instructions executable to:
initiate a request for remediation service for at least some of the components of the provider network.

15. The computer-readable memory medium of claim 12, wherein the Internet protocol television program is delivered on a pay-per-view basis.

16. The computer-readable memory medium of claim 12, wherein the Internet protocol television program is delivered on an on-demand basis.

17. The computer-readable memory medium of claim 12, further including program instructions executable to:
responsive to determining that the refund request is granted, credit a refund to an account associated with the client; and
notify the client that the refund has been credited.

18. The computer-readable memory medium of claim 12, wherein the event code includes a video trouble code.

19. The computer-readable memory medium of claim 12, wherein the Internet protocol television program is delivered from a video hub office.

20. The computer-readable memory medium of claim 12, wherein the Internet protocol television program is delivered from a satellite head-end office.

21. A system, comprising:
a processor; and
a memory, wherein the memory includes program instructions executable by the processor to:
receive a refund request initiated by a user of a provider network, wherein the refund request is associated with an Internet protocol television program requested by the user via the provider network;
receive user information;
validate the identity of the user using the user information;
retrieve a plurality of event codes associated with the user from an event database, wherein the event codes are indexed to components of the provider network; and
based at least in part on the user information and the retrieved plurality of event codes, determine whether the refund request is granted.

22. The system of claim 21, further including program instructions executable to:
initiate a request for remediation service for at least some of the components of the provider network.

23. The system of claim 21, wherein the event database includes a trouble validation engine that accesses the components of the provider network and stores the event codes.

24. The system of claim 21, wherein the multimedia output is a voice message.

25. The system of claim 21, wherein the multimedia output is an instant message.
